(19) United States
(12) Patent Application Publication
(10) Pub. No.: US 2012/0119510 A1
(43) Pub. Date: May 17, 2012

(54) PNEUMATIC GEARBOX WITH VARIABLE SPEED TRANSMISSION AND ASSOCIATED SYSTEMS AND METHODS

(76) Inventors: Brian Von Herzen, Minden, NV (US); Scott R. Frazier, Morrison, CO (US)

(21) Appl. No.: 13/183,427

(22) Filed: Jul. 14, 2011

Related U.S. Application Data
(60) Provisional application No. 61/364,364, filed on Jul. 14, 2010.

(51) Int. Cl. H02K 7/00; F03B 13/12; F03G 7/00; F03D 11/02; F03D 5/00; F03G 6/00

(52) U.S. Cl. 290/1 C; 60/325; 60/398; 290/55; 290/53

(57) ABSTRACT

The present technology is directed generally to pneumatic gearbox systems with variable speed transmission and associated systems and methods. In selected embodiments, pneumatic gearbox systems can include a variable input power source and a compressor operatively coupled thereto. The compressor can be configured to compress a fluid at a first cyclic frequency from the variable power input power source. The system can further include a storage vessel in fluid communication with the compressor and an expander in fluid communication with the storage vessel. The storage vessel can be configured to retain a volume of the fluid after compression until the expander draws upon it to expand the fluid at a second cyclic frequency different from the first cyclic frequency. The second cyclic frequency can be configured to synchronize with that of an electrical generator.

### CROSS-REFERENCE TO RELATED APPLICATION(S)

The present application claims priority to and the benefit of U.S. Provisional Patent Application No. 61/364,364, filed on Jul. 14, 2010 and entitled UNDERWATER COMPRESSED AIR ENERGY STORAGE SYSTEM OPERATION AND COMPONENTS, which is incorporated herein by reference in its entirety.

### TECHNICAL FIELD

The present technology is directed generally to gearboxes. In particular, the present technology is directed to pneumatic gearboxes with variable speed transmission and associated systems and methods.

### BACKGROUND

Power demand from an electric system can vary considerably throughout the day and between seasons. In order to improve the efficiency of an electric system, it is desirable to store excess and off-peak energy to utilize the stored energy when demand is high. Renewable energy sources (e.g., wind, wave, tidal, etc.) are typically variable (i.e., they supply intermittent and/or variable levels of energy), and can therefore also benefit from energy storage to provide a meaningful contribution to an electric system. There are several available energy storage systems that can accumulate energy for subsequent production of electricity, such as batteries, elevated hydro systems, and compressed air energy storage (CAES) systems.

Compressed air energy storage (“CAES”) systems compress air with a compressor, and the compressed air is stored in a geological formation (e.g., a cavern, aquifer, etc.) or other structure where it can be drawn upon when energy demands require. Typically, the compressed air mixes with natural gas, combusts and expands through a turbine to generate mechanical power that drives an electric generator to generate electricity. Mechanical gearboxes are used to convert the speed and torque from the power source (e.g., a renewable energy source) to interface with the electrical generator. However, mechanical gearboxes require substantial maintenance and tend to deteriorate faster than the systems they support. Direct drive generators can eliminate the need for these expensive mechanical gearboxes, but the complexity and associated maintenance of direct drive generators make them no less of a cost burden.

CAES systems are also constrained by geographic constraints and by the modest fixed volume of geological formations, and therefore typically operate at high variable pressures during energy storage and retrieval. This variable pressure decreases the efficiency of the compressor and the turbine, which operate at an optimal performance at a single design pressure. As a result, there exists a need for efficient and low-cost energy systems for use in CAES systems.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. Moreover, in the drawings, like reference numerals designate corresponding parts throughout the several views.

FIG. 1 is a schematic illustration of a pneumatic gearbox system configured to store and release compressed fluids in accordance with several embodiments of the present technology.

FIG. 2A is a partially schematic view of a pneumatic gearbox system in a representative environment in accordance with an embodiment of the present technology.

FIG. 2B is a partially schematic view of a pneumatic gearbox system configured in accordance with another embodiment of the present technology.

FIGS. 3A and 3B are partially schematic views of wind-powered pneumatic gearbox systems in representative environments in accordance with an embodiment of the present technology.

FIG. 4A are partially schematic view of a pneumatic gearbox system having an Archimedes screw device configured in accordance with an embodiment of the present technology.

FIG. 4B is a partially schematic view of a pneumatic gearbox system having an Archimedes screw device configured in accordance with another embodiment of the present technology.

FIG. 5A is a partially schematic view of a pneumatic gearbox system having an Archimedes screw device configured in accordance with yet another embodiment of the present technology, and FIG. 5B is a partial cutaway of the Archimedes screw device of FIG. 5A.

FIGS. 6A and 6B are partially schematic views of wind-powered pneumatic gearbox systems having Archimedes screw devices configured in accordance with further embodiments of the present technology.

FIG. 6C is a partially schematic view of a wind-powered pneumatic gearbox system having an Archimedes screw device configured in accordance with an additional embodiment of the present technology.

FIG. 7 is a partially schematic front view of a bi-directional positive-displacement rotary system configured in accordance with an embodiment of the disclosure.

### DETAILED DESCRIPTION

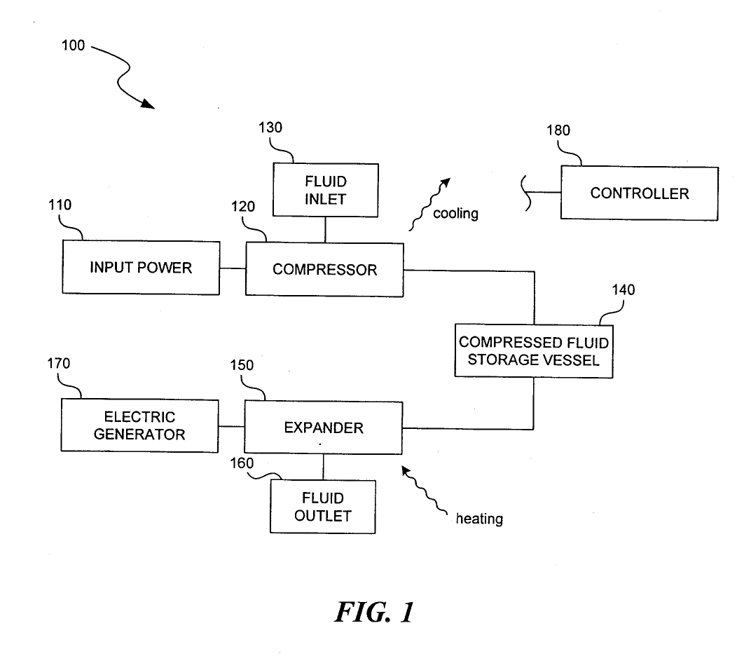

The present technology is directed generally to pneumatic gear-boxes with variable speed transmission and associated systems and methods. In several embodiments, for example, a pneumatic gearbox is configured to interface with a low-speed, variable mechanical power system (e.g., systems that derive power from renewable energy sources, such as wind and wave power) and with a high-speed electric generator. The pneumatic gearbox can compress a fluid at a first cyclic frequency, accumulate the compressed fluid in a storage vessel, and expand the compressed fluid upon demand. The fluid can be expanded at a second cyclic frequency different from the first cyclic frequency to interface with an electric generator that delivers electrical power to a grid. As used herein, the term “fluid” can include air, carbon dioxide, supercritical carbon dioxide, and/or any other suitable working fluid. The term “cyclic frequency” can refer to the rate of compression and/or expansion, measured in units of cycles per second (e.g., using a positive-displacement machine), such as a wind turbine, a Wankel engine, piston, and/or other devices that operate in one or more cycles. However, cyclic frequency is not limited to rotary, piston, or turbine devices. In various embodiments, the pneumatic gearbox eliminates the need for expensive gearboxes and/or direct drive systems that convert low-speed power input to a high-speed power output compatible with various electric generators and grids. In other embodiments, the technology and associated systems and methods can have different configurations, modes, components, and/or procedures. Still other embodiments may eliminate particular components or procedures described below with reference to FIGS. 1-7. A person of ordinary skill in the relevant art, therefore, will understand that the present technology may include other embodiments with additional elements, and/or may include other embodiments without several of the features shown and described below with reference to FIGS. 1-7.

### Overview

FIG. 1 is a schematic illustration of a pneumatic gearbox system 100 (“system 100”) configured to store and release compressed fluids in accordance with several embodiments of the present technology. The system 100 can include an input power source 110 from one or more mechanical and/or renewable energy systems. For example, the input power source 110 can include wind power (e.g., wind turbines), wave power (e.g., “Salter's Duck”), power from currents (e.g., hydrokinetic power), solar power (e.g., photovoltaic arrays or solar thermal arrays), and/or other suitable renewable energy systems. Renewable energy sources may provide variable power, such as intermittent power and/or variable power amplitudes. For example, wind turbines may generate more power during winter storms than during the summer, and may produce varying levels of power based on the speed and direction of the wind.

In other embodiments, the input power source 110 can derive from an electrical power grid (not shown). The system 100 can communicate with the electrical power grid (e.g., via a controller 180) such that electrical power can be drawn from the electrical power grid and stored as compressed fluid energy during off-peak hours (e.g., late evening, early morning), and then recovered during peak hours when energy can be drawn from system 100 to augment baseline power systems (e.g., coal, natural gas, diesel) and/or to sell the power at a premium. Conversely, to reduce the cost during peak power consumption, operation of the system 100 can be reversed such that the system 100 is the baseline power source and the traditional baseline power sources provide additional power during peak times when the load exceeds the supply from the system 100.

In further embodiments, the system 100 can include other suitable sources for input power source 110, including intermittently available power sources and/or sources that may be drawn during low-cost or off-peak hours and sold during more desirable times (e.g., peak electrical load, after the outage of power plant). In still further embodiments, the input power source 110 can derive power from multiple input power sources.

As shown in FIG. 1, the input power source 110 can be coupled to a compressor 120 that compresses fluid received from a fluid inlet 130. As discussed in greater detail below, the compressor 120 can be a positive-displacement machine, such as a piston-type compressor, a Wankel-type compressor, or an Archimedes screw-type compressor. In other embodiments, the compressor 120 can include other suitable compressors. Compression of the fluid via the compressor 120 can occur in one cycle, or in multiple cycles. As is understood by those skilled in the art, cooling can be introduced (e.g., via pumps, heat exchanges) between stages to increase the efficiency of compression. Cooling may also be achieved through direct contact between the compressed fluid and a cooling fluid (e.g., oceanic waters).

The system 100 can convey the compressed fluid from the compressor 120 to a storage vessel 140 for the compressed fluid. In various embodiments, the storage vessel 140 can be a substantially flexible bag, balloon, and/or other conformal fluid storage device that can be ballasted within a body of water or secured to the bottom of the body of water. For example, the storage vessel 140 can be submerged a depth of approximately 60 feet or more underwater in a lake, reservoir, ocean, and/or other suitable body of water. When the storage vessel 140 is flexible, the volume of the fluid contained within can conform isobarically to the amount of fluid compressed and the depth within the body of water. In other embodiments, the storage vessel 140 can be substantially rigid, such as a pipe or tank, and/or it can be positioned under or above water. In further embodiments, the storage vessel 140 can be an underwater device as described in the following U.S. patent applications: U.S. patent application Ser. No. 12/888,971, filed on Sep. 23, 2010, and entitled SYSTEM FOR UNDERWATER COMPRESSED FLUID ENERGY STORAGE AND METHOD OF DEPLOYING SAME; U.S. patent application Ser. No. 12/889,013, filed on Sep. 23, 2010, and entitled UNDERWATER COMPRESSED FLUID ENERGY STORAGE SYSTEM; and U.S. Provisional Application No. 61/309,415, filed on Mar. 1, 2010, and entitled UNDERWATER COMPRESSED AIR ENERGY STORAGE, each of which is herein incorporated by reference in its entirety.

To generate power, the compressed fluid may be transferred to an expander 150 that can expel the fluid into the environment at a generally standard or ambient pressure. In other embodiments, such when the fluid is hazardous to the environment (e.g., carbon dioxide), the fluid outlet 160 can dispel the fluid into a closed chamber where it can be disposed of or recirculated through the system 100. Expansion of the fluid generates mechanical power that may be conveyed to an electrical generator 170 where the mechanical power is converted into electrical power. The electrical generator 170 can be any suitable electrical generator 170. Once the electrical power is generated, it can be conveyed to an electrical power grid and/or other electrically powered devices. The power may be transmitted via DC or NC lines. Accordingly, the system 100 can step up electrical power to provide a high A/C voltage that can be transmitted to a load or grid.

As explained in further detail below, the expander 150 can be a Wankel-type expander, an Archimedes screw-type expander, and/or other suitable fluid expander. In selected embodiments, the compressor 120 and the expander 150 can be combined into a single device (i.e., a compression/expansion device or “C/E” device).

The expander 150 can expand the compressed fluid at a cyclic frequency different from the cyclic frequency at compression. Accordingly, the system 100 can convert the low frequency (e.g., low RPM), low torque power produced by many renewable energy systems (e.g., wind turbines) to interface with electrical generators (e.g., the electrical generator 170) that have high-frequency (e.g., high RPM), and low torque, and therefore the system 100 eliminates the need for expensive mechanical gearboxes and direct drive systems.

The heating associated with compression and the cooling associated with expansion can decrease the efficiency of the system 100. Accordingly, various embodiments of the technology include forced-convection cooling to cool the fluid in the compressor 120, and forced-convection heating to heat the fluid in the expander 150. In embodiments where the storage vessel 140 is at substantially ambient temperature and pressure (e.g., at a depth within a body of water), both cooling for compression and heating after expansion may be performed using the water that surrounds system 100. This allows the system 100 to operate in a substantially isothermal manner that cools the fluid to near ambient during the compression stage(s) and heats the fluid to near ambient during the expansion stage(s). In other embodiments, system 100 can store energy via a controlled heat transfer process to a thermal storage tank (not shown), and energy to heat the fluid after expansion is drawn from the thermal storage tank via pumps or other suitable devices.

Referring still to FIG. 1, the controller 180 can be operably coupled to one or more of the components of the system 100. The controller 180 can perform computer-executable instructions, including routines executed by a programmable computer. The term “computer” refers generally to personal and networked computers or other data suitable processors (e.g., cellular and mobile phones, tablets, multi-processor systems, etc.) The routines or subroutines may be located in local and remote memory storage devices, such that the controller 180 can remotely control the system 100.

The system 100 can have particular applicability in the context of renewable energy sources. In particular, many renewable energy sources (e.g., wind, wave, solar, tidal, etc.) provide energy in a manner that varies over time. The system 100 can provide an efficient mechanism to accumulate energy (e.g., build up and store a reserve of energy) and release energy at a later time. This allows renewable energy sources to operate at variable speeds, rather than at a fixed speed, and therefore increases the amount of power generated and improves the efficiency with which such renewable energy systems operate.

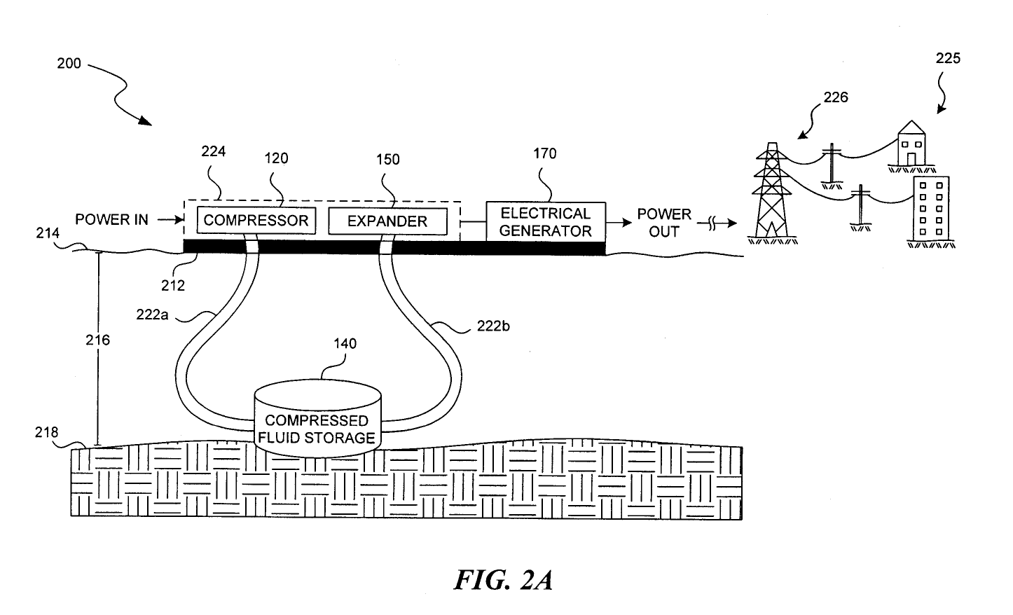

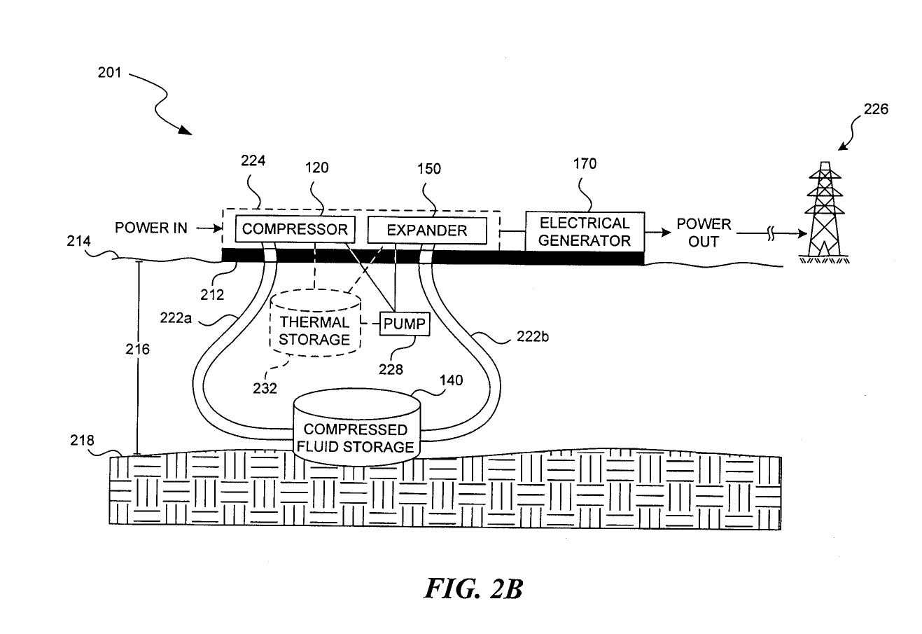

FIG. 2A is a partially schematic view of a pneumatic gearbox system 200 (“system 200”) in a representative environment in accordance with an embodiment of the present technology. The system 200 includes several features discussed above with reference to FIG. 1. For example, the system includes the compressor 120, the storage vessel 140, the expander 150, and the electrical generator 170. In the illustrated embodiment, the compressor 120, the expander 150, and the electrical generator 170 are positioned offshore on a platform 212 proximate to the surface 214 of a body of water. The body of water can be an ocean, lake, reservoir, dammed river, and/or other suitable body of water. The storage vessel 140 is positioned at a depth 216 below the surface of the water 214. The storage vessel 140 can be affixed to a seafloor 218 as shown in FIG. 2A, or it can be ballasted to float at an average depth 216 above the seafloor 218. The term “seafloor” is used generally throughout the specification to refer to the bottom of any body of water, such as lakes, rivers, reservoirs, etc.

Fluid passageways 222 (identified individually as a first fluid passageway 222a and a second fluid passageway 222b) can connect the compressor 120 and the expander 150 with the submerged storage vessel 140 such that compressed fluid can flow to and from the storage vessel 140. In several embodiments, the compressor 120 and the expander 150 can be combined into a single C/E device 224 (as indicated by the broken lines) such that only one fluid passageway 222 is necessary to couple the C/E device 224 to the storage vessel 140. In further embodiments, the system 200 can include more than two fluid passageways 222. For example, multiple fluid passageways 222 can be coupled to the compressor 120 and/or to the expander 150 to transmit higher volumes of compressed fluid to and from the storage vessel 140. In other embodiments, additional compressors 120 and expanders 120 with corresponding fluid passageways 222 can be added to the system 200.

The rigidity or flexibility of the fluid passageways 222 can be selected depending upon whether the surface unit (e.g., the compressor 120, the expander 150, etc.) attached to the fluid passageways 222 is floating or affixed to the seafloor 218. In deeper waters, for example, renewable energy harvesting schemes typically use a floating platform that is anchored to the seafloor 218 such that wind, wave, or other elements may move the platform until the anchor lines are tensioned. To accommodate this movement, flexible tubes or other flexible fluid passageways 222 may be used. Conversely, rigid fluid passageways 222, such as pipes, are well suited for more stationary surface units. In other embodiments, more rigid fluid passageways 222 can be used with anchored surface units and configured such that the deflection strain over the length of the fluid passageways 222 is within its structural limits.

As power is introduced into the system 200 (e.g., via renewable energy sources), the compressor 120 can compress a fluid, and the first fluid passageway 222a can transfer the compressed fluid to the storage vessel 140. When energy loads 225 demand additional energy from a grid 226, the expander 150 can draw the compressed fluid from the storage vessel 140 via the second fluid passageway 222b and expand the fluid to drive the electrical generator 170. The separate compressor 120 and expander 150 configuration shown in FIG. 2A allows energy (i.e., compressed fluid) to be simultaneously supplied to the storage vessel 140 and drawn therefrom. The expansion of the fluid generates mechanical power that can be converted by the electrical generator 170 into electricity compatible with the grid 226. In various embodiments, the expander 150 can operate at a higher cyclic frequency than the compressor 120 such that it can interface with the generator 170. For example, the compressor 120 can operate at a first cyclic frequency and the expander 150 can operate at a second cyclic frequency higher than the first cyclic frequency. In other embodiments, the first and second fluid passageways 222a and 222b can consist of a single fluid passageway 222 extending from the storage vessel 140 to the C/E device 224.

FIG. 2B is a partially schematic view of a pneumatic gearbox system 201 (“system 201”) configured in accordance with another embodiment of the present technology. They system 201 includes generally similar features as the system 200 described above with reference to FIG. 2A. For example, the system 201 includes the compressor 120, the expander 150, and the electrical generator 170 positioned on the offshore platform 212 and coupled to the submerged storage vessel 140. The system 201 further includes a pump 228 (e.g., a conventional mechanical pump) configured to feed water directly from the body of water in which it is positioned to the compressor 120 and the expander 150 to provide cooling and heating during compression and expansion, respectively.

The system 201 can optionally include a thermal storage vessel 232 (e.g., a tank, pipe, flexible bag, etc.) coupled to the compressor 120 and the expander 150 via the pump 228 and configured to extract energy (i.e., heat) during compression and supply energy during expansion. In various embodiments, the thermal reservoir 232 can be sufficiently large such that thermal stratification occurs therein. This allows hot water to be drawn from the upper portion of the thermal reservoir 232, and cold water to be drawn from the lower portion of the thermal vessel 232. For example, during compression, cold water for cooling can be drawn from the lower portion of the thermal reservoir 232 to the compressor 120. The water is heated during compression and fed back into the thermal reservoir 232 where it settles in the upper portion for use during expansion and/or other operations requiring heat. In lieu of the thermal reservoir 232, relatively cold water can be extracted from lower depths of the body of water and relatively warmer water can be extracted proximate to the surface of the water. Accordingly, the system 200 can operate in an isothermal mode, or in an adiabatic mode, with intercooling wherein cold water is supplied to the compressor 120 between compression stages and/or interwarming wherein hot water is supplied to the expander 150 from the thermal storage vessel 232 during expansion.

As shown in FIG. 2B, the thermal storage vessel 232 can be immersed in the water, and therefore algae and other sea life can be encouraged to grow and reside on its outer surface to enhance insulation. In other embodiments, the thermal storage vessel 232 can be positioned on the platform 212, on the seafloor 218, or on land.

In various embodiments, electro-chlorination can reduce or prevent biofouling when seawater is introduced into the system 200 (e.g., for cooling and heating). Electro-chlorination can be performed as the seawater enters the system through an electrolysis process that produces sodium and chlorine ions in excited states that act as a temporary biocide (e.g., 15-30 minutes) against buildup of organisms on the surfaces of a heat exchanger or like structure. A short time after electro-chlorination, the seawater returns to a ground state such that no long-lasting biocides are added to the seawater. In other embodiments, DC or AC pulsed electricity can be used through metallic walls of a heat exchanger at regular intervals to reduce the buildup of organisms.

In operation, several embodiments of the system 200 can eliminate or at least reduce the high cost of a mechanical gearbox, while enabling the effective coupling of a low-rpm energy device to a high-rpm electrical generator. The low cyclic frequency device compresses the fluid, optionally storing it for later use, while the expander takes pressurized air and drives a higher frequency generator. Accordingly, the system 200 can provide efficient and inexpensive generation of electricity.

### Wind-Powered Pneumatic Gearbox Systems

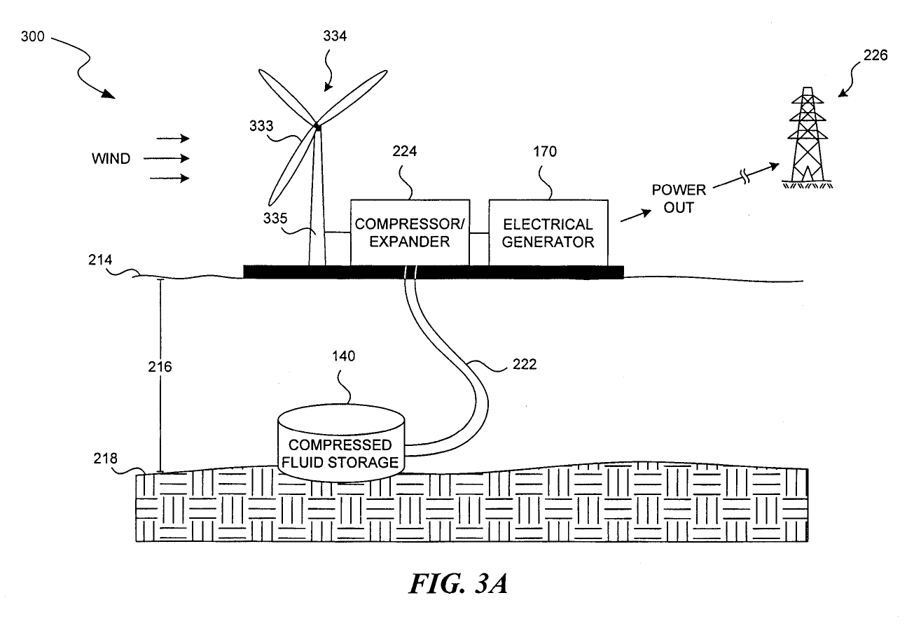

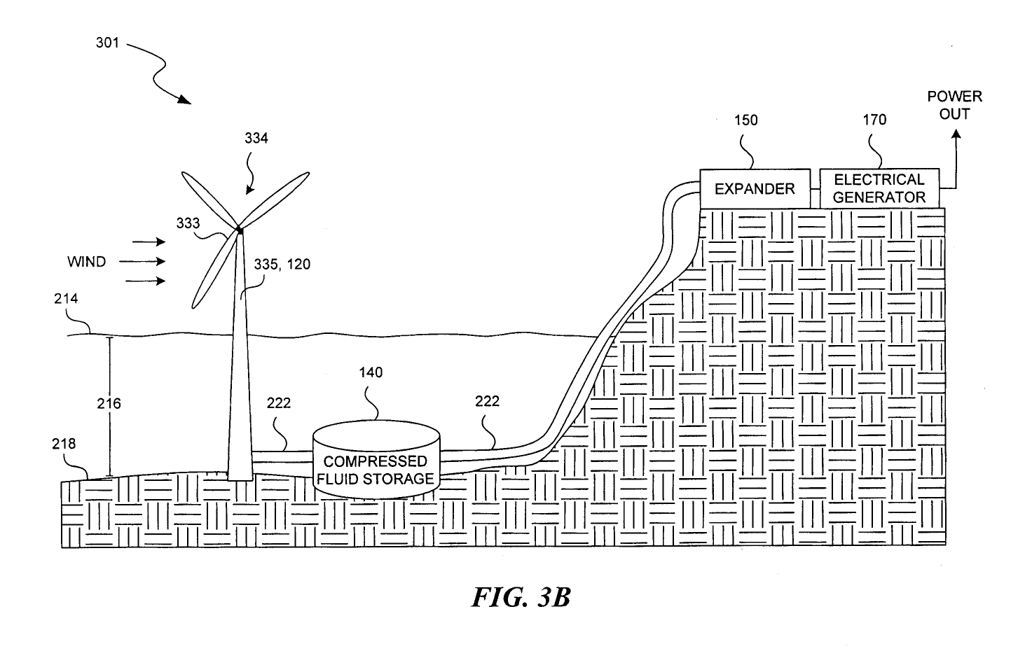

FIGS. 3A and 3B are partially schematic views of wind-powered pneumatic gearbox systems 300 and 301 (“systems 300 and 301”) in representative environments in accordance with an embodiment of the present technology. The systems 300 and 301 include generally similar features as the system 200 described above with reference to FIG. 2A. In the system 300 illustrated in FIG. 3A, however, the compressor 120 and the expander 150 are combined as a single C/E device 224 such that one fluid passageway 222 can transfer the compressed fluid to and from the storage vessel 140.

As further shown in FIG. 3A, the system 300 can further include a wind turbine 334 floating above the water on the offshore platform 212. Wind can turn propeller blades 333 of the wind turbine 334 causing low RPM and high torque on a shaft 335 of the wind-turbine 334 that drives the C/E device 224 to compress a fluid (e.g., air). The compression speed of the C/E device 224 may vary according to the speed of the wind. The compressed fluid can flow down the fluid passageway 222 to the storage vessel 140 and be drawn therefrom when power is needed. The compressed fluid can be expanded to generate a high RPM relative to the low RPM wind turbine 334. For example, in selected embodiments, the electric generator 170 can turn synchronously to a 50/60 Hz cycle that can be used for AC electricity production that can be transmitted to the grid 226 on shore. Thus, C/E device 224 operates at a particular speed during expansion and at other speeds during compression, depending on the wind magnitude in this example. Accordingly, the pneumatic gearbox system 300 facilitates conversion of wind-power to electrical power, without the complexity and cost of conventional mechanical gearboxes. Additionally, in the embodiment illustrated FIG. 3A, the C/E device 224 and the electric generator 170 share the same platform 212 as the wind turbine 334, and thereby reduce the capital costs of required marine infrastructure associated with getting the stored power to shore.

Referring now to FIG. 3B, similar to the system 300 described with reference to FIG. 3A, the system 301 uses the wind turbine 334 to drive compression of a fluid. In the illustrated embodiment, the wind platform 335 of the wind turbine 334 extends to the seafloor 218. In various embodiments, the wind platform 335 itself can house the compressor 120. For example, as the wind rotates the shaft 335, multiple stages of compression can take place down the shaft 335 such that the wind turbine 334 can drive large piston compressors (not shown) with each stage increasing the pressure of the fluid in hydrostatic equilibrium with the surrounding water. In addition, as shown in FIG. 3B, at least some of the compression can be bathed in the surrounding water. In fact, the higher pressure stages where more heat is commonly dissipated and more power is commonly transferred are typically positioned underwater, where heat transfer is most critical and also most available. This approach can provide thermal equilibration with the surrounding water that results in quasi-isothermal compression through multiple stages.

At the base of the wind turbine 334, the compressed fluid moves to the storage vessel 140. When power is needed, the compressed fluid can be piped to an onshore expander 150 and electric generator 170 to produce electrical power. These onshore power generation components can eliminate costs associated with offshore setup and operation of the expander 150 and the electrical generator 170. Like the system 300 discussed above, the system 301 shown in FIG. 3B can interface the low RPM power generated by the wind turbine 334 with the high RPM electric generator 170. Additionally, the system 301 can harvest and store variable energy inputs from the wind turbine 334 (i.e., due to the variability of wind) in the storage vessel 140, and the stored energy that can be subsequently used to generate non-variable power (i.e., stable power).

The systems 300 and 301 described with reference to FIGS. 3A and 3B use the wind turbine 334 to generate power. However, in other embodiments, the systems 300 and 301 can be used in conjunction with other wind-powered systems (e.g., wind pumps, windmills), other variable and/or renewable power systems, and/or other energy sources.

### Archimedes Screw-Type Pneumatic Gearbox Systems

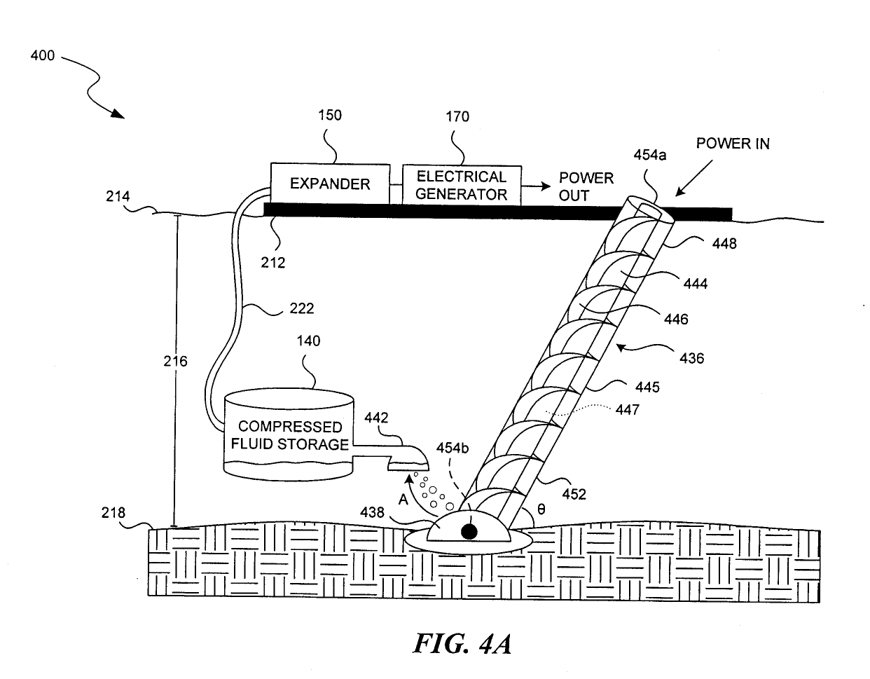

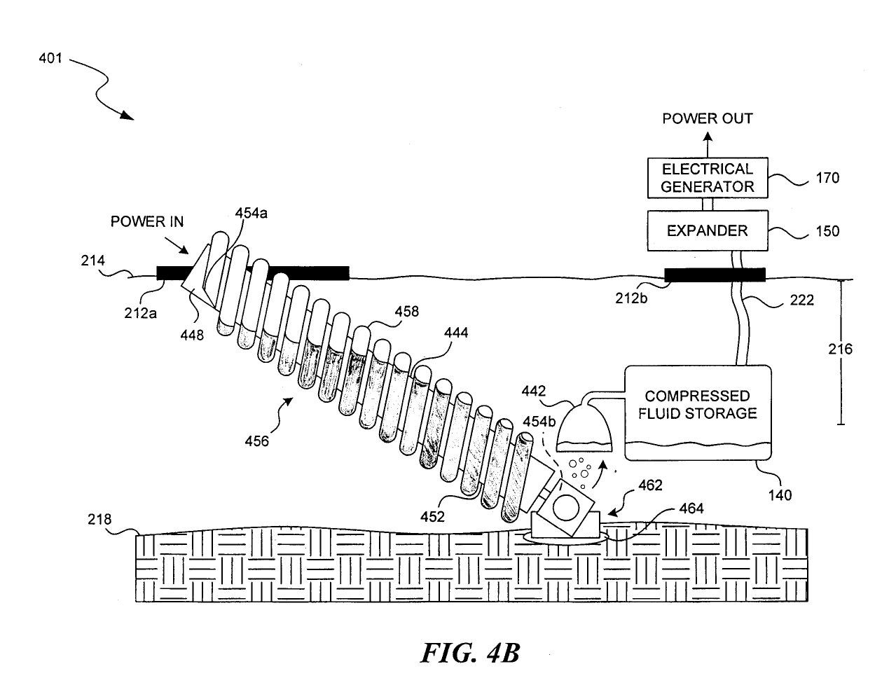

FIG. 4A is a partially schematic view of a pneumatic gearbox system 400 (“system 400”) configured in accordance with an embodiment of the present technology. The system 400 can include features generally similar to features in the systems described above. The system 400 further includes an Archimedes screw device 436 (“screw device 436”) that operates in a substantially isothermal mode to provide compression and/or expansion to the system 400. In the embodiment illustrated in FIG. 4A, the screw device 436 includes a helix or spiral 446 fitted around a center shaft 444 and enclosed by an outer cylinder 445. The screw device 436 can further include a first opening 454a at a first end portion 448 and a second opening 454b at a second end portion 452 in fluid communication with the spiral 446. The first end portion 448 is positioned at or near the surface of the water 214 supported by the platform 212, and the second end portion 452 is spaced laterally apart from the first end portion 448 and rotatably coupled to an underwater support 438 such that the screw device 436 forms a zenith angle θ with a substantially horizontal seafloor 218 in the illustrated embodiment. The underwater support 438 affixes the Archimedes screw device 436 to the seafloor 218, but in other embodiments the underwater support 438 can be ballasted at a depth below the water surface 214. The underwater support 438 can include a bearing or other suitable structure that facilitates rotation of the screw device 436. In various embodiments, the screw device 436 can be spring loaded to absorb wave motion (e.g., with a shock absorber between support 438 and the platform 212). As described in further detail in FIG. 4B, selected embodiments of the underwater support 438 can be configured to provide the Archimedes screw device 436 with various degrees of freedom such that it can move in response to changes in waves, current, wind, and/or commands from a controller (not shown).

An input power source (e.g., a renewable energy system, motor, etc.) can drive the screw device 436 (e.g., the shaft 444 and the outer cylinder 445) such that it rotates about the underground support 438. The screw device 436 can be configured to rotate as a whole such that the spiral 446, the shaft 444 and the outer cylinder 445 rotate together to provide a simplified compressor with only one moving part. Unlike conventional Archimedes screws that pump fluids upwards, the screw device 436 in the illustrated embodiment is configured as a compressor that pumps slugs of fluid and water downward from the first end portion 448 to the second end portion 452 under hydrostatic equilibrium at incremental depths of the screw device 436. As the screw device 436 rotates through 360°, it captures both air and water via the first opening 454a to form a bubble of air in a portion of the circumference surrounded by water within the screw device 436. The spiral 446 drives the air down toward the second end portion 452 at an angle, causing each air bubble to shrink and compress as they descend.

The screw device 436 can include one or more features to compensate for the shrinking air bubbles and maintain compression throughout the length of the screw device 436. For example, in selected embodiments, the pitch of the spirals 446 can be decreased (i.e., the spirals 446 can be positioned closer together) as the compression increases (i.e., toward the second end portion 452) to decrease the volume within the more compressed portions of the screw device 436. In other embodiments, the diameter of the inner shaft 444 can be increased and/or the diameter of the outer cylinder 445 can be decreased along the length of the screw device 436. In further embodiments, the outer cylinder 445 can include apertures that allow additional water to be entrained in the screw device 436 without releasing air.

The compressed air can be released via the second opening 454b and stored within the storage vessel 140. In various embodiments, the compressed air is at local hydrostatic pressure when it is expelled from the second opening 454b, and therefore the storage vessel 140 or a portion thereof must be positioned above the second opening 454b to capture the rising bubbles. For example, as shown in the illustrated embodiment, the system 400 can include an inverted funnel 442 positioned above the second opening 454b to collect the compressed air bubbles as they rise in the direction of the arrow A. As shown in FIG. 4A, both air and water can enter the storage vessel 140 via the inverted funnel 442. The compressed air and water will naturally rise to upper and lower portions, respectively, of the storage vessel 140. In other embodiments, the system 400 can include a separation chamber that divides the compressed air from the water. When energy is needed, the compressed air can fed through the expander 150 to generate mechanical power having a different frequency than the input power, and can therefore interface with the electrical generator 170. As would be understood by one of skill in the art, the funnel 442 or other collection assembly can alternatively be coupled to a turntable (FIG. 4B) with a stationary collar collector (not shown) that collects the air for the storage vessel 140 regardless of the orientation of the screw device 436. In this way, the system 400 can be configured to accommodate rotation of the turntable, while preserving operations of compression and storage.

In selected embodiments, the screw device 436 can be reversed such that it effectuates expansion of the compressed air. When the compressed air in the storage vessel 140 is at local atmospheric pressure, the second end portion 452 of the screw device 436 can be raised (e.g., via a controller) above the storage vessel 140 to capture out-flowing air (e.g., using an inverted funnel at the second opening 454b). Alternatively, the storage vessel 140 can route the compressed air into the second opening 454b. The compressed air can be allowed to periodically exit the reservoir and drive the screw device 436 in the reverse direction to expand the air and drive the electrical generator 170 at the surface of the water 214.

During compression and expansion, the air bubbles exchange heat with the water entrained within the spiral 446 of the screw device 436 and with the exterior body of water via the outer cylinder 445. For example, as air is drawn downward during compression, the water outside the screw device 436 provides substantial cooling, and the direct contact of the air with the slugs of water within each turn of the spiral 446 can further enhance cooling as a result of the substantially higher heat capacity of the water than air (e.g., 3,000 times higher per unit volume at standard temperature and pressure). Additionally, the rotation of the screw device 436 ensures the exterior cylinder 445 is continuously wetted by the water to further enhance cooling.

The stable stratification of a body of water can also facilitate cooling as the air compresses and warming as the air expands. For example, due to thermal stratification, the upper portions of the screw device 436 are surrounded by relatively higher temperature water proximate to the surface of the water and the lower portions of the screw device 436 are surrounded by relatively lower temperature water proximate to the seafloor 218. During compression, the air bubbles are cooled by the surrounding water as they descend through the screw device 436 such that the temperature of the compressed air is substantially equal to the surrounding water once the air bubbles reach the second end portion 452 of the screw device 436. Therefore, less work must be performed to compress the air and the system 400 increases in efficiency. Similarly, during expansion, the expanding air can be warmed by the surrounding water as it ascends through the screw device 436 to enhance the efficiency of expansion. Accordingly, the enhanced heat exchange of the screw device 436 eliminates the need for an intervening heat exchanger.

In several embodiments, the shaft 444 of the screw device 436 can have a hollow core that defines a cavity 447. During compression, cold water from the depths of the water can be upwelled against the flow of stable stratification of the water using a pump and/or motor. The cold water can move from the second end portion 452 of the screw device 436 to the first end portion 448 via the cavity 447 to enhance cooling. Similarly, warm water from the surface of the water 214 and/or a thermal reservoir can be down-welled from the first end portion 448 to the second end portion 452 to enhance heating during expansion. This additional heating and cooling during expansion and compression, respectively, can increase the efficiency of the screw device 436 and allow more work to be extracted. In further embodiments, a hollow conduit can be positioned around the outer cylinder 445 to further enhance heating and/or cooling.

FIG. 4B is a partially schematic view of a pneumatic gearbox system 401 (“system 401”) having an Archimedes screw device 456 (“screw device 456”) configured in accordance with another embodiment of the present technology. The system 401 and the screw device 456 can have generally similar features as the system 400 and the screw device 436 described above with reference to FIG. 4A. As shown FIG. 4B, however, the screw device 456 and the expander 150 are spaced apart from one another on separate platforms 212 (identified individually as a first platform 212a and a second platform 212b) such that the screw device 456 functions as the compressor 120 and transfers compressed air to the expander 150 via the fluid passageway 222.

In the embodiment illustrated in FIG. 4B, the screw device 456 includes a tube 458 wound helically around the shaft 444. The first end portion 448 of the screw device 456 extends partially above the surface of the water 214 such that water can enter the tube 458 via the first opening 454a. The second end portion 452 of the screw device 456 is coupled to a hinged joint 462 and a turntable 464 that adjust the zenith angle and azimuth, respectively, of the screw device 456 such that it can pivot in response to currents, instructions from a controller (not shown), wind, etc. Similar to the screw device 436 described above with reference to FIG. 4A, the screw device 456 captures and compresses air by interleaved entrainment of air and water as the screw device rotates through 360°.

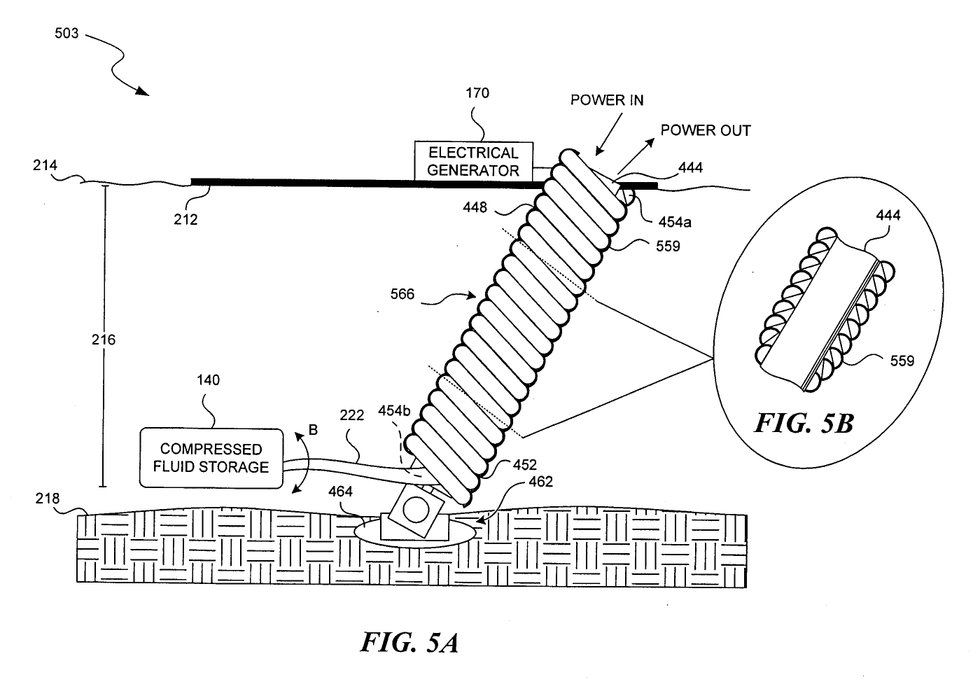

FIG. 5A is a partially schematic view of a pneumatic gearbox system 500 (“system 500”) having an Archimedes screw device 566 (“screw device 566”) configured in accordance with yet another embodiment of the present technology. FIG. 5B is a partial cutaway of the screw device 566 of FIG. 5A. The system 500 can have generally similar features as the systems 400 and 401 described above with reference to FIGS. 4A and 4B. Additionally, the screw device 566 can have similar feature as the screw device 456 described with reference to FIG. 4B. However, as shown in FIG. 5B, rather than a full tube helically wound around the shaft 444, the screw device 566 includes spiral tubing 559 that is cut in half or otherwise formed into a substantially semicircular shape, which may simplify mounting the tubing 559 on the shaft 444.

The tubing 559 is attached to the shaft 444 such that the first opening 454a forms an umbrella or cup shape that captures a semicircle of air as it rotates at an angle to the surface of the water 214. Once captured, the air will rise as a bubble toward the top of the tubing 559, while the water settles underneath. As the screw device 566 continues to rotate and capture more slugs of air, the air bubble will remain positioned toward the top of each rung of the tubing 558 as it spirals downward toward the second end portion 452 of the screw device 566. Accordingly, the air is therefore held at a local maximum as it travels downward through the tubing 559, thus maintaining hydrostatic pressure through compression as the air bubble descends.

In the embodiment illustrated in FIG. 5A, the electrical generator 170 and/or other energy source can drive the screw device 566 to compress the air. To move the air to the storage vessel 140, the fluid passageway 222 can be operated at a slight overpressure to ambient pressure, permitting the air and water to pass downward in accordance with the lower arrow B to position the interface between the fluid passageway 222 and the storage vessel 140 at a point below the second opening 454b. To release the air from the storage vessel 140, the fluid passageway 222 can be below the second opening 454b to allow the compressed air to flow into the screw device 566, where it can be expand a different cyclic frequency or speed than it was compressed. Accordingly, the screw device 566 can serve as both the compressor and expander.

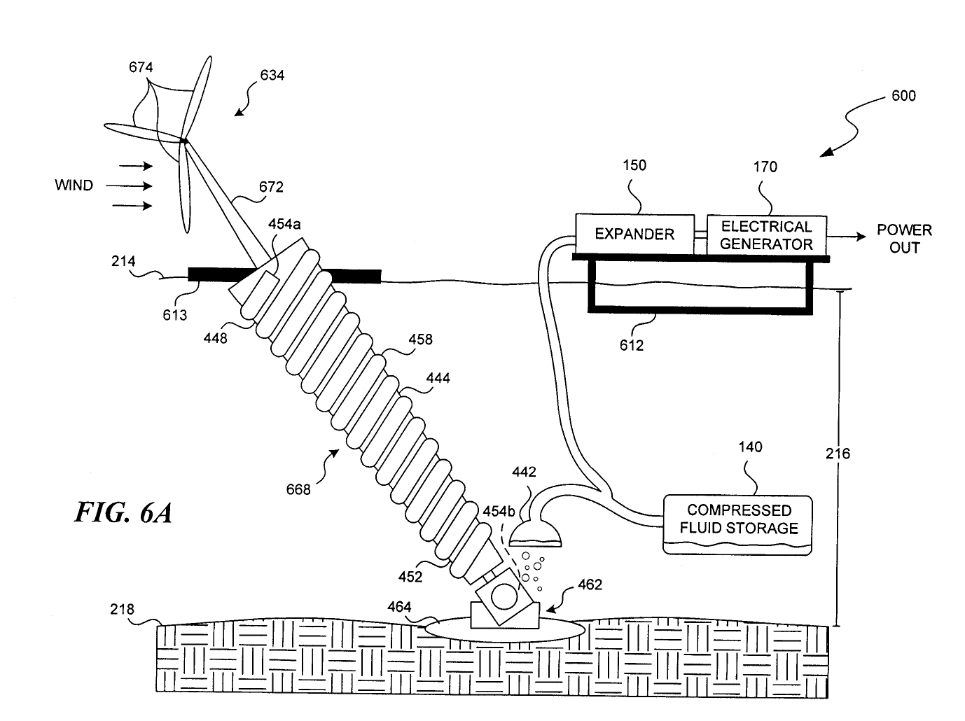

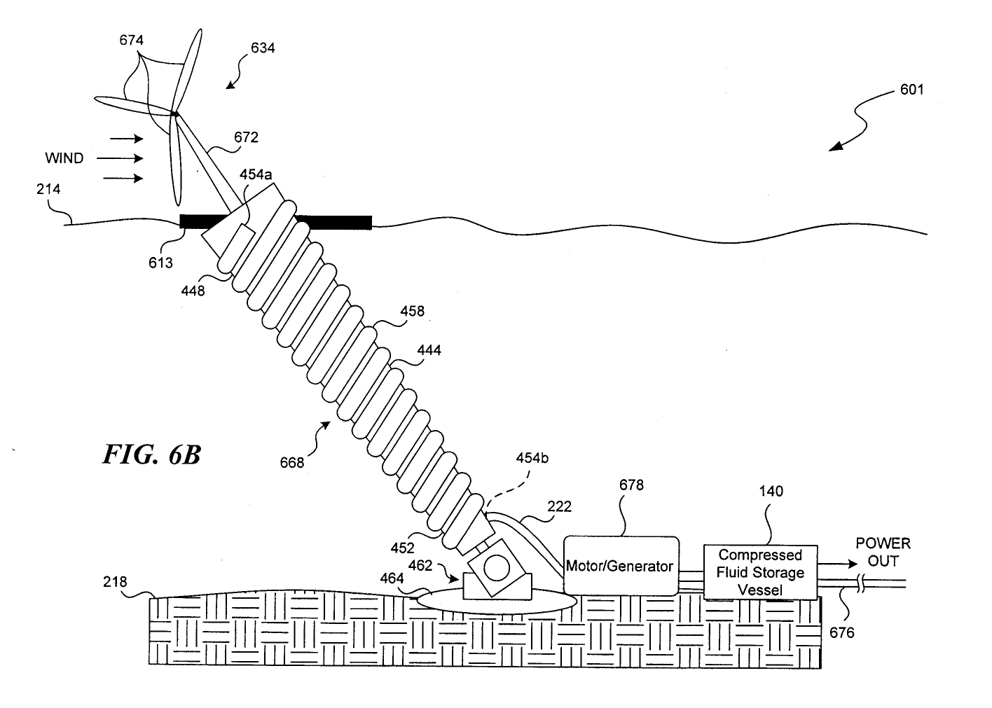

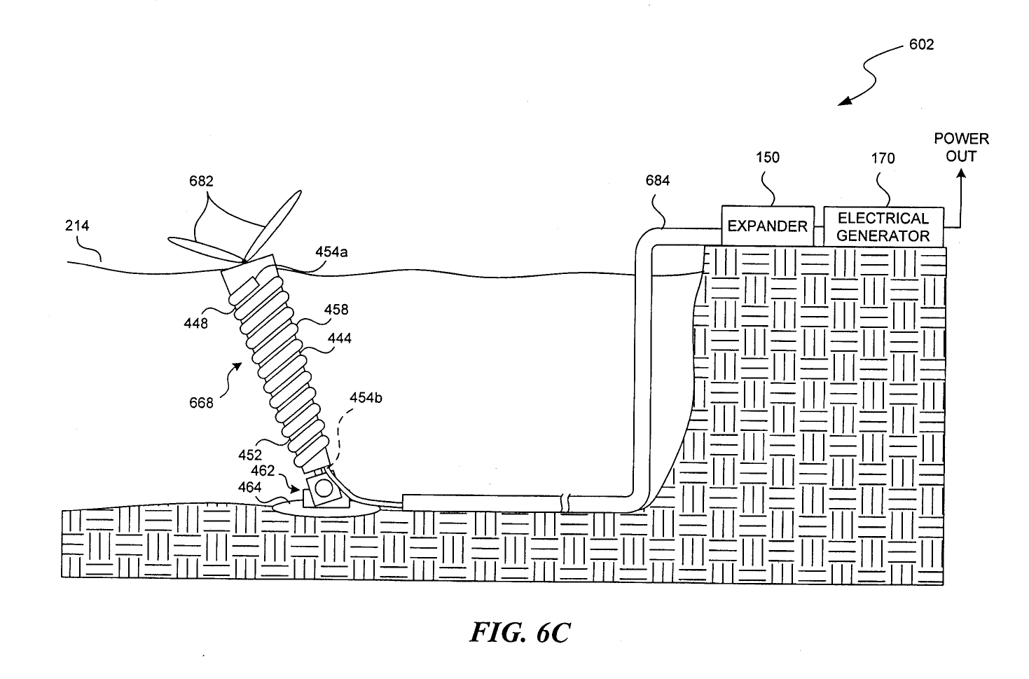

FIGS. 6A and 6B are partially schematic views of wind-powered pneumatic gearbox systems 600 and 601 (“systems 600 and 601”) configured in accordance with further embodiments of the present technology. The systems 600 and 601 can include generally similar features as the systems described above. Referring to FIGS. 6A and 6B together, the systems 600 and 601 can include an Archimedes screw device 668 (“screw device 668”) that has substantially similar features as the screw devices 436 and 566 described above with reference to FIGS. 4B-5B. For example, the screw device 668 can include a full or partial portion of tubing 458 helically wrapped around the shaft 444 that entrains air and water to compress and/or expand the air. As shown in FIGS. 6A and 6B, the diameter of the shaft 444 decreases from the first end portion 448 to the second end portion 452 to maintain hydrostatic equilibrium throughout compression and expansion (e.g., reducing the volume of the tubing 458 as the volume of the air compresses). In other embodiments, the screw device 668 includes other features that facilitate hydrostatic equilibrium during compression and/or expansion.

As further shown in FIGS. 6A and 6B, the systems 600 and 601 can further include a wind turbine 634 having a shaft 672 coupled to the shaft 444 of the screw device 668. In other embodiments the shaft 672 and/or other portions of the wind turbine 634 can be coupled to the screw device 668. The wind turbine 634 can include blades 674 that are feathered at an angle correlated to the slope of the screw device 668 to keep the blades 674 from contact with the water surface as they rotate. When wind blows, the feathered blades 674 rotate and, in turn, cause the screw device 668 to rotate. A buoyancy collar 613 and/or other flotation inside or outside the shaft 444 of the screw device 668 can keep the first end portion 448 of the screw device 668 at the surface of the water 214 such that it can entrain water and air at the first opening 454a. The air and water are carried through the tubing 458 down the length of the screw device 668 to isothermally compress the air as it remains in contact with the water. At the second end portion 452, the turntable 464 fixes the screw device 668 in position, but allows rotation with the wind.

Referring to FIG. 6A, the wind turbine 634 can drive the screw device 668 to rotate at high torque and low RPM as air is compressed through the tubing 458 until it is released from the second opening 454b into the ballasted (e.g., with sediment) storage vessel 140. The compressed air can then be conveyed to a separate platform 612 where the expander 150 and the electrical generator 170 can operate at a higher cyclic frequency, generate electrical power, and route it to shore. Optionally, the compressed air can bypass the storage vessel 140 to delivery compressed air directly to the expander 150.

Turning now to FIG. 6B, a motor/generator 678 can be positioned underwater proximate to the screw device 668. In various embodiments, the motor/generator 676 can be affixed to the turntable 464. As the compressed air exits the screw device 668, it can pass through a central rotating shaft of the motor/generator 676 into a non-rotating element, and into the storage vessel 140. An undersea electrical cable or pressurized air hose 676 can connect the system 601 to shore for energy transfer. In other embodiments, such as with all of the systems discussed above, the storage vessel 140 can be eliminated or bypassed to move the air directly from compression to expansion.

As discussed above, to further enhance the performance (e.g., power generated) of the screw device 668, propellers and/or other fluid conveyance mechanisms can be coupled to the screw device 668 to convey cold water up a hollow portion of the shaft 444 during compression (i.e., to cool the air), and conveying warm water down from the surface of the water 214 during expansion (i.e., to warm the air).

In selected embodiments, the first end portion 448 of the screw device 668 can be coupled to a linear spring / universal joint to constrain the location of the screw device 668 at the surface of the water 214. For example, the screw device 668 can use such a linear spring-universal joint configuration when it is connected to a ship. This allows for rotational and longitudinal degrees of freedom for the ship in response to surface waves, while still enabling an on-board motor/generator to generate power and mechanical work during charge (i.e., compression) and discharge (i.e., expansion) cycles.

FIG. 6C is a partially schematic view of a wind-powered pneumatic gearbox system 602 (“system 602”) including the screw device 668 of FIGS. 6A and 6B. Many of the features of the system 602 are generally similar to those described above with reference to FIGS. 6A and 6B. In the illustrated embodiment, however, the system 602 includes feathered wind turbine vanes or blades 682 attached to the outer portion of the shaft 444 that can turn about the screw device 668 in response to current flow. The feathering of the blades 682 facilitates the operation of the wind turbine and direct coupling of the screw device 668 with reduced clearance from the blades 682 to the water surface 214. This allows the system 602 to harness wind energy, and drive the rotation of the screw device 668 to provide compression and/or expansion. As further shown in FIG. 6C, the compressed air can be directed into a pipe 684 wherein the compressed air can be stored for a period and then transferred to shore for energy production.

In the embodiments described above with reference to FIGS. 4B-6C, the tubing 448, 559 is shown having a circular or semi-circular shape. However, in other embodiments, the tubing 448, 559 can have other suitable shapes. For example, the tubing 448, 559 can be oval, rectangular, trapezoidal, and/or other suitable shapes. Additionally, the illustrated embodiments show representative systems that are driven by wind energy (FIGS. 4A-6C). However, in other embodiments, the systems can be driven using other renewable and non-renewable energy sources, such as currents, waves and tides.

### Wankel-Style Pneumatic Gearbox Systems

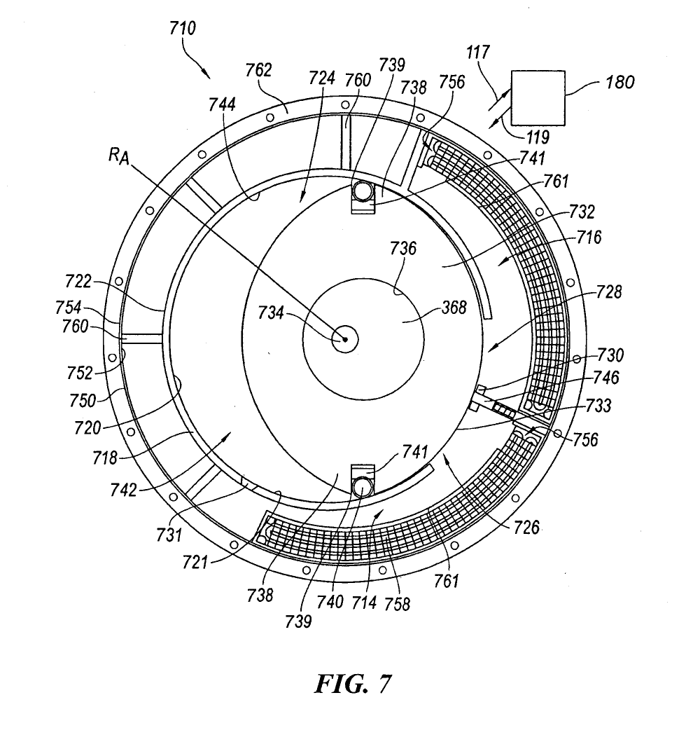

Embodiments of the pneumatic gearbox system alternately use rotary Wankel-style compressors, expanders, and/or bidirectional C/E devices. FIG. 7, for example, is a partially schematic front view of a two-lobed rotary displacement system 710 (“system 710”) configured in accordance with an embodiment of the disclosure. The system 710 can include a first fluid passageway 714, a second fluid passageway 716, and chamber housing 718 having an inner wall 720 and an outer wall 722. The first fluid passageway 714 can have working fluid at a first pressure and the second passageway 716 can have working fluid at a second pressure higher or lower than the first pressure. The chamber housing 718 at least partially surrounds a pressure-modifying chamber 724. In a particular embodiment shown in FIG. 7, the pressure-modifying chamber 724 is generally circular, but in other embodiments the chamber 724can have a modified oval, oblong, trochoidal, or other curved shape. The pressure-modifying chamber 724 can further include a first port 726 connecting the first passageway 714 to the pressure-modifying chamber 724 and a second port 728 connecting the second passageway 716 to the pressure-modifying chamber 724. Accordingly, the first and second ports 726, 728 extend through the chamber housing 718. In several embodiments of the present disclosure, there is no valve between the pressure-modifying chamber 724 and the first passageway 714 and/or between the pressure-modifying chamber 724 and the second passageway 716, as will be discussed in further detail later.

In several embodiments of the disclosure, the system 710 includes a bidirectional compressor/expander, configured to operate as a compressor in a first mode and an expander in a second mode. Depending on the operational mode of the system 710 (e.g., whether it is being run as a compressor or an expander), the first port 726 operates as an inlet port or an outlet port and the second port 728 performs the opposite function, e.g., it operates as an outlet port or an inlet port. For example, in a first mode, in which the system 710 is running as a compressor, the rotor 732 rotates in a first direction, the first port 726 functions as an inlet port (feeding low-pressure working fluid, or flow, into the compression chamber 724), and the second port 728 functions as an outlet port (accepting compressed working fluid and feeding it to the first passageway 714). In the second mode, in which the system is running as an expander, the rotor 732 rotates in a second direction opposite the first direction, the first port 726 operates as an outlet port, the second port 728 operates as an inlet port, and the direction of flow through the system 710 is reversed. In other embodiments, the system 710 operates as a dedicated compressor or expander instead of operating bidirectionally. In particular embodiments, the system 710 can have more than two ports. For example, in some embodiments, the system 710 can have two inlet ports and two outlet ports. The ports 726, 728 can be rectangular with rounded corners or otherwise shaped. The ports 726, 728 are positioned in the chamber housing 718 in manners that differ in different embodiments of the disclosure, as will be described in further detail later. In any of these embodiments, individual ports (e.g., the first port 726 and the second port 728) are separated from each other by a partition 730 of the chamber housing 718.

The system 710 can further include a rotor 732 coupled to and eccentrically rotatable relative to a shaft 734 which runs through a center portion 736 of the rotor 732. An eccentric cam 768 is further coupled to the shaft 734 and is positioned in the center portion 736 of the rotor 732. The rotor 732 can have a plurality of lobes 738. Although the rotor 732 illustrated in FIG. 7 includes two lobes 738, in other embodiments it can have three or more lobes. The lobes 738 can have various shapes, curvatures, and dimensions in different embodiments of the disclosure. In general, each lobe 738 extends radially outwardly from the center portion 736 of the rotor 732 by a greater amount than do the neighboring regions of the rotor 732 such that a peripheral boundary 733 of the rotor 732 is non-circular. Each lobe has a tip 739 at the radially outermost point of the lobe 738. The shaft 734 extends into (e.g., traverses) the chamber 724 along a rotational axis R_{A} normal to the plane of FIG. 7. The shaft 734 can be electrically and/or mechanically connected to a motor, a generator, or a motor/generator (shown schematically in FIG. 1). The rotor 732 is actuated by rotating the shaft 734 and the cam 768. The rotation direction of the shaft 734 determines the rotation direction of the rotor 732 and whether the system 710 is operating as a compressor or an expander. As will be discussed in further detail below with reference to FIG. 3, gears can be added in some embodiments to effect rotor rotation.

In the illustrated embodiment, both the first port 726 and the second port 728 are radially positioned. In other words, the ports 726, 728 are positioned on a surface 721 of the chamber housing 718 that is generally parallel to the rotational axis R_{A}. As the rotor 732 makes orbital revolutions around the shaft 734, the lobe tips 739 rotate past the first and second ports 726, 728 and cyclically cover and uncover the first and second ports 726, 728.

Seals (e.g., tip rollers 740) on the lobes 738 seal the rotor 732 against the inner wall 720 of the chamber housing 718. The tip rollers 740 can be generally cylindrical and are mounted to the lobes 738 via a roller-mount 741, such as a gear-free wheel-and-axle apparatus or a spherical wheel system. The rollers 740 can be forced against the rotor walls in a modulated manner by springs or other pressure devices (e.g., as disclosed in U.S. Pat. No. 3,899, 272) that provide low-friction contact with the chamber housing inner wall 720 and guide the rotor position. The rollers 740 can also help ensure that pressurized fluid does not escape from a chamber zone 742 bounded by the rotor 732 and the housing inner wall 720. In other embodiments, other tip-sealing features, such as sliding seals, liquid films, and/or a purposefully placed gap space between the lobe 738 and the inner wall 720 of the chamber housing 718 can be used. In one embodiment, for example, a thin film of liquid can be applied to the chamber housing 718 or the lobe tips 739. In some embodiments, the thin film can comprise seawater, freshwater, oil, glycol, glycerin, and/or another material, or a combination of materials. The thin film can provide a higher flow resistance across a gap between the tip 739 and the chamber housing inner wall 720. In other embodiments, air bearings can be applied to the tip 739 to seal the chamber zone 742742 with minimal friction. In at least some embodiments, the inner wall 720 of the pressure-modifying chamber 724 and/or portions of the rotor 732 can include one or more low-friction coatings 744. The coating 744 can include plastic, ceramic, or other materials. In low-temperature applications, a low-friction coating (e.g., Teflon, epoxy, polycarbonate, cross-linked polyethylene, and/or other material) can improve the integrity of the seal, while providing relatively low friction between the rotor 732 and the chamber 724 and without incurring the expense of a high temperature seal.

The separation portion 730 between the first port 726 and the second port 728 can carry a seal, e.g., a variable geometry seal 746. The variable geometry seal 746 can engage with the peripheral boundary 733 of the rotor 732 as the rotor 732 eccentrically rotates in the chamber 724. The variable geometry seal 746, in combination with the rotor periphery 733 and rollers 740 contacting the inner wall 720 of the chamber housing 718, divides the chamber 724 into individual chamber zones 742 having individual zone pressures. In the illustrated position, the chamber 724 has only one chamber zone 742 due to the orbital orientation of the rotor 732. Rotating the rotor 732 alters the size and number of the zones 742.

The orbital position of the rotating rotor 732 with respect to the chamber housing inner wall 720 can determine the size of the chamber zones 742 and the pressure of the fluid within the zones 742. For example, the rotor 732 illustrated in FIG. 7 is oriented in the equivalent of a bottom dead center position. In the compression mode, the rotor 732 rotates in a first rotation direction (e.g., clockwise) about the eccentric shaft 734 to deliver compressed working fluid to a high-pressure passageway (e.g., the second passageway 716). In the expansion mode, the rotor 732 rotates in the opposite direction to deliver expanded working fluid to a low-pressure passageway (e.g., the first passageway 714). As discussed above with reference to FIG. 1, the system 710 can include a controller 180 that can control the rotation direction of the rotor 732, which in turn determines whether the system 710 operates to compress or expand. The controller 180 may accordingly receive inputs 117 (e.g., from sensors and/or an operator) and provide outputs 119 to direct the rotor 732. The controller 180 can redirect the rotation of the rotor 732 by mechanical, electrical, electromechanical and/or other suitable devices. For example, in several embodiments the controller 180 controls the rotation direction and torque of the shaft 734. In some embodiments, the controller 180 can perform functions in addition to controlling the bidirectionality of the system 710. In any of these embodiments, the controller 180 can include any suitable computer-readable medium programmed with instructions to direct the operation of the system 710.

The system 710 can further include a heat exchanger 758 positioned outside the chamber housing 718. The heat exchanger 758 can include a heat exchanger passageway 756 in fluid communication with one or more of the first and second passageways 714, 716 and/or the chamber 724. In one embodiment, a heat exchanger housing wall 761 positioned between the heat exchanger passageway 756 and the first and/or second passageways 714, 716 channels fluid flow between the heat exchanger passageway 756 and the first and/or second passageways 714, 716. The fluid can be channeled to enhance working fluid contact with the heat exchanger 758. The heat exchanger 758 can be dedicated to providing heating or cooling, or can be bidirectional to cool fluid processed by the chamber 724 during compression and heat the fluid during expansion. In other embodiments, fluid is injected directly into the chamber 724 and/or a passageway 714, 716, or 756 by one or more nozzles 731, such as an atomizing spray nozzle. The injected fluid can be colder or hotter than the working fluid in the chamber 724, and can accordingly cool or heat the working fluid in addition to or in lieu of the heat transfer provided by the heat exchanger 758.

An outer housing 750 can at least partially surround or encase the chamber housing 718, the first passageway 714, and the second passageway 716. The outer housing 750 can have an inner surface 752 and an outer surface 754. The outer housing 750 can be radially spaced apart from the chamber housing 718 to provide room for the passageways 714, 716, 756, the heat exchanger 758, stabilizing features 760 (e.g., standoffs), an insulator material (not shown in FIG. 7), and/or other components. In FIG. 7, the outer vessel 750 is illustrated as being generally cylindrical, but in other embodiments it can be other shapes and/or can only partially surround the chamber housing 718. The outer housing 750 can be axially adjacent to one or more bulkheads 762. In the illustrated embodiment, only one axial bulkhead 762762 is shown so as to not obscure the inner-workings of the system 710, but in other embodiments the outer housing 750 can be sandwiched between two axial bulkheads 762762. In this manner, the outer housing 750 and the bulkheads 762 can form a pressure vessel for the flow within the system 710. Accordingly, the inner surface 752 of the outer housing 750 and the bulkheads 762762 contact and/or contain pressurized flow passing through the system 710. Using the outer housing 750 as a pressure vessel can reduce the material requirements for the overall system 710.

As mentioned above, the inner wall 720 of the chamber housing 718 can have one or more coatings 744 to reduce friction and/or manage wear. The coating 744 can be applied to other surfaces of the system 710 (in addition to or in lieu of the inner wall 720), e.g., other surfaces of the chamber housing 718, the outer housing 750, the rotor 732, the passageways 714, 716, the fluid passageways 756, the heat exchanger 758, the bulkheads 762 and/or the shaft 734, in order to achieve desired functional or material characteristics such as heat resistance or corrosion resistance. For example, when the system 710 is used for combustion engine applications, high-temperature coatings, such as ceramics, can be used to protect the surfaces from hot fluids. In low temperature compressor applications, plastic coatings can be used to improve corrosion resistance and reduce friction at lower cost. Further features of the system 710 are described in U.S. patent application Ser. No. 13/038,345, filed on Mar. 1, 2011, and entitled ROTARY COMPRESSOR-EXPANDER SYSTEMS AND ASSOCIATED METHODS OF USE AND MANUFACTURE, which is herein incorporated by reference in its entirety.

In the embodiment illustrated in FIG. 7, one intake and one compression stroke can occur for each 360-degree rotation of the shaft. This is in contrast to other disclosed embodiments of a rotary Wankel C/E that typically has one compression per 180-degree rotation of the shaft. Thus, for reasons of efficiency and as understood in the art, one compression/expansion per respective directional rotation may result in larger air plumes that reduce losses by having a one-cycle operation with one compression per rotation. In other words, one compression cycle may be caused to occur for one rotation of the shaft in one direction, and one expansion correspondingly occurs for one rotation of the shaft in the opposite or reverse direction. As a result, several embodiments of the system 710 can improve the efficiency relative to a two-cycle/rotation design by correspondingly increasing the sizes of passages ways through which working fluids pass.

Additionally, compression losses represent an undesirable conversion of energy to heat. Air passing through a small hole or will experience a pressure drop that causes irrecoverable loss of energy. By decreasing the number of compressions per cycle in the system, more degrees of rotation are available, which in turn enables the plenum on the side of the C/E to be larger. Such larger plenums reduce losses and thus improve efficiency.

Moreover, the chamber ports keep the peak-flow speeds reasonable, often less than 50 meters per second, to avoid losses. The volumetric flow is tied to the rotor rotational speed and the eccentricity of the cam, which affects the displacement per rotation. The pressure ratio of the stage affects the location of the edge of the exhaust port. It is generally beneficial to make the ports as large as possible, thus lowering the average exit velocity. One of skill in the art of mechanical design can vary these parameters to optimize the geometry for a given pressure ratio per stage.

From the foregoing, it will be appreciated that specific embodiments of the technology have been described herein for purposes of illustration, but that various modifications may be made without deviating from the technology. For example, several features of the disclosure are discussed in the context of wind-powered systems. Many of these features can be applied in the context of systems powered by other renewable and non-renewable energy sources. Certain aspects of the technology described in the context of particular embodiments may be combined or eliminated in other embodiments. For example, each of the pneumatic gearbox system described above include one power input system and one power output. However, a plurality of pneumatic gearbox systems and components can be combined into a single system with multiple power inputs and/or outputs. Additionally, in an alternate embodiment, an Archimedes screw device may be housed in a bath through which cooling and heating liquid may pass. In such an embodiment, energy from the heat of compression can be extracted and stored (e.g., in a thermal reservoir) such that energy can then be drawn from storage during expansion to heat the Archimedes screw device. Further, while advantages associated with certain embodiments have been described in the context of those embodiments, other embodiments may also exhibit such advantages and not all embodiments need necessarily exhibit such advantages to fall within the scope of the present technology. Accordingly, the present disclosure and associated technology can encompass other embodiments not expressly described or shown herein.

I/we claim:

1. A pneumatic gearbox system, comprising:
a variable power source;
a compressor operatively coupled to the variable power source, wherein the compressor is configured to compress a fluid at a first cyclic frequency;
a storage vessel in fluid communication with the compressor and configured to retain a volume of the compressed fluid;
an expander in fluid communication with the storage vessel and configured to expand the fluid at a second cyclic frequency different from the first cyclic frequency; and
an electrical generator coupled to the expander, wherein the electrical generator is configured to operate at the second cyclic frequency.

2. The pneumatic gearbox system of claim 1 wherein the fluid comprises air.

3. The pneumatic gearbox system of claim 1 wherein the fluid comprises carbon dioxide.

4. The pneumatic gearbox system of claim 1 wherein the fluid comprises supercritical carbon dioxide.

5. The pneumatic gearbox system of claim 1 wherein the second cyclic frequency is higher than the first cyclic frequency.

6. The pneumatic gearbox system of claim 1 wherein the electricity generated from the electrical generator is substantially synchronized to an AC phase of an electrical wiring system.

7. The pneumatic gearbox system of claim 6 wherein the AC phase is approximately 50/60 Hz.

8. The pneumatic gearbox system of claim 1 wherein at least one of the compressor and the expander comprises a positive-displacement device.

9. The pneumatic gearbox system of claim 1 wherein:
the compressor comprises an Archimedes screw device having a first end portion and a second end portion opposite the first end portion, the first and second end portions each having at least one opening;
the first end portion is positioned partially above a body of water;
the second end portion is submerged within the body of water, the second end portion being in fluid communication with the storage vessel, and the Archimedes screw device positioned at an angle such that the first and second end portions are spaced laterally apart from one another; and
the variable power source is configured to rotate the Archimedes screw device such that the Archimedes screw device captures and compresses the fluid by interleaved entrainment of the fluid and water via the opening at the first end portion.

10. The pneumatic gearbox system of claim 9 wherein:
the fluid comprises air; and
the body of water comprises at least one of an ocean, a sea, a river, and a lake.

11. The pneumatic gearbox system of claim 9, further comprising:
a bearing rotatably coupled to the second end portion of the Archimedes screw device;
a hinged joint coupled to the bearing, wherein the hinged joint is configured to adjust a zenith angle of the Archimedes screw device; and
a turntable rotatably coupled to the hinged joint, wherein the turntable is configured to adjust an azimuth of the Archimedes screw device.

12. The pneumatic gearbox system of claim 9, further comprising a funnel in fluid communication with the storage vessel, wherein the funnel is positioned vertically above the opening of the second end portion and configured to capture the compressed fluid released from the second opening.

13. The pneumatic gearbox system of claim 9 wherein:
the Archimedes screw device comprises a center shaft having a hollow core, wherein the hollow core defines a passageway; and
the Archimedes screw device is configured to upwell cold water through the passageway during compression.

14. The pneumatic gearbox system of claim 9 wherein:
the variable power source is configured to rotate the Archimedes screw device in a first direction to drive compression of the fluid; and
the Archimedes screw device is configured to rotate in a second direction opposite the first direction to drive expansion of the fluid from the second end portion to the first end portion.

15. The pneumatic gearbox system of claim 9 wherein the variable power source comprises a wind-powered device coupled to the first end portion of the Archimedes screw device, and wherein the wind-powered device is configured to rotate the Archimedes screw device.

16. The pneumatic gearbox system of claim 9 wherein the Archimedes screw device comprises a tube helically wound around a shaft, wherein the tube has an opening at the first end portion that receives discrete slugs of the fluid as the Archimedes screw device rotates.

17. The pneumatic gearbox system of claim 9 wherein the Archimedes screw device comprises a plurality of apertures in fluid communication with the body of water, the apertures being configured to receive a larger volume of the water at the second end portion of the Archimedes screw device than at the first end portion.

18. The pneumatic gearbox system of claim 9 wherein the Archimedes screw device comprises:
a shaft;
a tubing wound helically around the shaft.

19. The pneumatic gearbox system of claim 18 wherein the tubing comprises helical windings that decrease in pitch from the first end portion of the Archimedes screw device to the second end portion.

20. The pneumatic gearbox system of claim 18 wherein the shaft decreases in diameter from the first end portion of the Archimedes screw device to the second end portion.

21. The pneumatic gearbox system of claim 1 wherein:
the expander comprises an Archimedes screw device having a first end portion and a second end portion opposite the first end portion, the first and second end portions each including at least one opening;
the first end portion is positioned at least partially above a body of water;
the second end portion is submerged within the body of water, the second end portion being in fluid communication with the storage vessel; and
the variable power source is configured to rotate the Archimedes screw device such that fluid and water from the storage vessel enter the Archimedes screw device via the opening at the second end portion, and wherein the rotation drives expansion of the fluid as it moves toward the first end portion.

22. The pneumatic gearbox system of claim 21 wherein the Archimedes screw device comprises a shaft having a hollow core, wherein the hollow core defines a cavity, and wherein the Archimedes screw device is configured to downwell warm water through the cavity during expansion.

23. The pneumatic gearbox system of claim 1 wherein the expander and the compressor are at least partially positioned on an offshore platform.

24. The pneumatic gearbox system of claim 1 wherein:
the expander is submerged underwater; and
the pneumatic gearbox system further comprises an underwater link configured to transmit energy to shore.

25. The pneumatic gearbox system of claim 1 wherein the storage vessel is submerged within a body of water.

26. The pneumatic gearbox system of claim 1 wherein at least one of the compressor and the expander comprises a Wankel rotary engine.

27. The pneumatic gearbox system of claim 1 wherein the compressor and the expander are combined in a single compressor/expander device.

28. The pneumatic gearbox system of claim 1 wherein the storage vessel comprises a pipeline.

29. The pneumatic gearbox system of claim 1 wherein the storage vessel comprises at least one rigid tank.

30. The pneumatic gearbox system of claim 1 wherein the variable power source is configured to supply intermittent power to the compressor.

31. The pneumatic gearbox of claim 1 wherein the variable power source comprises at least one of a wind-powered system, a solar-powered system, a wave-powered system and a tidal-powered system.

32. The pneumatic gearbox system of claim 1 wherein:
the variable power source has a first cyclic frequency and a first torque;
the electric generator has a second speed higher than the first cyclic frequency and a second torque lower than the first torque; and
the expander is configured to supply mechanical power to the electric generator at the second cyclic frequency.

33. The pneumatic gearbox system of claim 1, further comprising an electrochlorination system configured to reduce biofouling agents from entering the pneumatic gearbox system through incoming water.

34. A pneumatic gearbox system, comprising:
a compressor configured to compress a fluid at a first cyclic frequency, wherein the compressor is operably coupled to a variable renewable power source;
a storage vessel in fluid communication with the compressor and configured to store a volume of the fluid after compression; and
an expander in fluid communication with the storage vessel and configured to expand the fluid at a second cyclic frequency higher than the first cyclic frequency, wherein the compressor and the expander are positive displacement machines.

35. The pneumatic gearbox system of claim 34 wherein:
the variable renewable power source is a wind turbine positioned over a body of water; and
the storage vessel is positioned underwater.

36. The pneumatic gearbox system of claim 35 wherein:
the compressor and expander are positioned on an offshore platform; and
the pneumatic gearbox system further comprises an electrical generator operably coupled to the expander and configured to operate at the second cyclic frequency.

37. The pneumatic gearbox system of claim 35 wherein:
the compressor is positioned on an offshore platform;
the expander is positioned onshore; and
the pneumatic gearbox system further comprises an electrical generator operably coupled to the expander and configured to operate at the second cyclic frequency.

38. The pneumatic gearbox system of claim 35 wherein the storage vessel is coupled to the compressor and the expander via at least one of a tube and a pipe.

39. The pneumatic gearbox system of claim 35 wherein:
the compressor comprises an Archimedes screw device having a first end portion partially submerged in the water and a second end portion rotatably coupled to an underwater support, wherein the first end portion is opposite the second end portions and the first and second end portions are spaced laterally apart;
the wind-turbine is configured to rotate the Archimedes screw device to capture air and water at the first end portion and compress the air as it moves to the second end portion; and
the expander is operably coupled to an electrical generator, wherein the electrical generator is configured to operate at the second cyclic frequency.

40. The pneumatic gearbox system of claim 39 wherein:
the wind turbine is configured to rotate the Archimedes screw device in a first direction to compress the fluid from the first end portion to the second end portion; and
the electrical generator is configured to rotate the Archimedes screw device in a second direction opposite the first direction to expand fluid from the second end portion to the first end portion.

41. The pneumatic gearbox system of claim 39 wherein:
the Archimedes screw device comprises a helical winding around a shaft, the shaft having a hollow core;
the pneumatic gearbox system further comprises motor configured to move water proximate the second end portion of the Archimedes screw device to the first end portion via the hollow core during compression to reduce the heat of compression.

42. The pneumatic gearbox system of claim 39 wherein:
the wind turbine comprises flanged blades; and
the Archimedes screw device comprises a shaft coupled to the flanged blades.

43. The pneumatic gearbox system of claim 39 wherein the underwater support is a universal joint configured to adjust the zenith angle and the azimuth of the Archimedes screw.

44. The pneumatic gearbox system of claim 34 wherein the compressor comprises at least one of a Wankel engine and a piston.

45. The pneumatic gearbox system of claim 34 wherein the variable renewable power source comprises at least one of a solar-powered energy source, a wind-powered energy source, a wave-powered energy source and a tidal powered energy source.

46. The pneumatic gearbox system of claim 34 wherein:
the variable renewable power source is positioned on a body of water; and
the storage vessel is positioned underwater.

47. The pneumatic gearbox system of claim 46 wherein the storage vessel comprises a rigid pipe extending to an onshore grid.

48. A method of generating power, comprising:
compressing a fluid with a compressor operating at a first cyclic frequency, wherein the compressor is driven by a variable power source;
storing the compressed fluid in a storage vessel; and
expanding the compressed fluid with an expander operating at a second cyclic frequency different from the first cyclic frequency, wherein the second cyclic frequency is configured to substantially synchronize with a cyclic frequency of an electric generator.

49. The method of claim 48 wherein:
compressing the fluid comprises compressing the fluid with a first positive-displacement rotary machine positioned on an offshore platform;
storing the compressed fluid comprises storing the compressed fluid in a submerged storage vessel;
expanding the fluid comprises expanding the fluid with a second positive-displacement rotary machine, wherein the second cyclic frequency is higher than the first cyclic frequency; and
the method further comprises generating electricity with the electrical generator coupled to the second positive-displacement rotary machine.

50. The method of claim 49, further comprising transferring the compressed fluid via at least one of a flexible tube and a pipe from the storage vessel to the second positive-displacement rotary machine, wherein the second positive displacement rotary machine and the electrical generator are positioned onshore apart from the offshore platform.

51. The method of claim 49, further comprising transferring the compressed fluid via at least one of a flexible tube and a pipe from the storage vessel to the second positive-displacement rotary machine, wherein the second-positive displacement rotary machine is positioned on the offshore platform.

52. The method of claim 49 wherein generating electricity comprises generating electricity synchronous with an AC phase of approximately 50/60 Hz.

53. The method of claim 48 wherein compressing and expanding the fluid comprises compressing and expanding the fluid with one positive-displacement rotary machine.

54. The method of claim 48, further comprising generating mechanical power at the first cyclic frequency with the variable power source, and wherein the variable power source is a renewably power source.

55. The method of claim 48 wherein introducing the fluid comprises introducing at least one of carbon dioxide and supercritical carbon dioxide.

56. The method of claim 48 wherein storing the compressed fluid comprises transporting the compressed fluid from the compressor to at least one of a rigid pipe and a rigid tank.

57. The method of claim 48 wherein storing the compressed fluid comprises transporting the compressed fluid from the compressor to at least one of a flexible tube and a flexible bag in fluid communication with a surround body of water.

58. The method of claim 48 wherein introducing the fluid comprises electrochlorinating the fluid before entry into the compressor.

59. The method of claim 48 wherein introducing the fluid into the compressor comprises:
introducing air into an Archimedes screw device via a first opening positioned partially underwater, the Archimedes screw device extending underwater at an angle to a second opening positioned a depth underwater; and
rotating the Archimedes screw device such that the Archimedes screw device captures plumes of the air via the first opening and compresses the air via interleaved entrainment of air and water as the Archimedes screw device rotates through 360 degrees.

60. The method of claim 48 wherein expanding the compressed fluid comprises:
introducing compressed air into an Archimedes screw device via an opening proximate the storage vessel, wherein the Archimedes screw device extends at an angle from a first end portion partially underwater to a second end portion positioned a depth underwater, and wherein the opening is at the second end portion; and
rotating the Archimedes screw device such that the Archimedes screw device captures plumes of the air via the opening and expands the air toward the first end portion as it rotates.
